(19) United States
(12) Patent Application Publication
(10) Pub. No.: US 2026/0357084 A1
(43) Pub. Date: Nov. 12, 2026

(54) CRACK-SENSITIVE HIGH-EFFICIENCY DEICING COATING AND PREPARATION METHOD

(71) Applicant: Dalian University of Technology, Dalian (CN)

(72) Inventors: Yahua LIU, Dalian (CN); Chenguang LU, Dalian (CN); Xu WANG, Dalian (CN); Zichao YUAN, Dalian (CN); Hailong ZHANG, Dalian (CN); Jiamin CHEN, Dalian (CN); Zeyu XIAO, Dalian (CN); Yishan CHEN, Dalian (CN); Shile FENG, Dalian (CN)

(21) Appl. No.: 19/714,854

(22) Filed: Jun. 22, 2026

(30) Foreign Application Priority Data
Dec. 2, 2025 (CN) 202511793914.2

(51) Int. Cl. C09D 5/16; C09D 5/02; C09D 7/41; C09D 7/43; C09D 7/45; C09D 7/65; C09D 7/80; C09D 183/04

(52) U.S. Cl. CPC C09D 5/1675; C09D 5/022; C09D 5/027; C09D 7/41; C09D 7/43; C09D 7/45; C09D 7/65; C09D 7/80; C09D 183/04

(57) ABSTRACT

The present disclosure relates to the field of anti-icing functional materials and especially relates to a crack-sensitive high-efficiency deicing coating and preparation method. The coating can be constructed in a single step by spraying an emulsion paint and achieves highly efficient deicing based on crack-sensitive effect at a thickness of only ~50 μm. The present disclosure utilizes in-situ cross-linking at the emulsion interface to achieve a one-step construction of an anti-icing coating with heterogeneous modulus. The cross-linking mechanism transforms the droplets in the emulsion into hard particles with uniform particle sizes (~5-20 μm) that are randomly distributed within the soft coating. The disclosed high-efficiency deicing coating exhibits a crack-sensitive effect, providing excellent static and dynamic passive deicing performance that enables both self-weight detachment of large-area ice sheets and efficient ice removal from rotating blades (e.g., drone rotors and wind turbine blades).

### TECHNICAL FIELD

The present disclosure relates to the field of anti-icing functional materials and especially relates to a crack-sensitive high-efficiency deicing coating and preparation method.

### BACKGROUND

Ice accumulation often causes systemic disruptions in sectors such as transportation and energy, posing safety risks and resulting in economic losses. To achieve energy-efficient and environmentally friendly anti-icing and deicing solutions, the development of passive anti-icing coatings has become a major research focus in recent years. Due to the complexity of natural environments, surface icing is often difficult to prevent. Therefore, designing anti-icing surfaces with stable and highly efficient deicing capabilities is crucial for practical applications.

Recently, anti-icing surfaces with crack-promoting capabilities have demonstrated significant potential for highly efficient deicing. Such anti-icing surfaces typically use soft polymers as film-forming matrix and incorporate cavity structures (Soft Matter. 2018, 14:4846-4851), softer gel phases (Mater. Horiz. 2019, 6:758-766), or the incorporation of harder particles (CN115851118) and fibers (CN116493217) to create surfaces with modulus heterogeneity. This causes local stress concentrations at the ice-substrate adhesion interface when subjected to force, leading to buckling deformation of the soft substrate and the formation of voids (i.e., interfacial cracks), which significantly reduces ice adhesion strength. Nevertheless, these surfaces struggle to facilitate efficient extension of interfacial cracks—the viscoelasticity of soft polymer chains often causes interfacial voids to slip under shear stress, limiting deicing efficiency. An improved approach involves depositing a hard film onto the soft substrate to form a natural micro-wrinkle structure (Natl. Sci. Rev. 2025, 12: nwaf005). The soft substrate is responsible for generating buckling deformation, while the hard wrinkle structure triggers interfacial cracks and promotes brittle fracture at the interface, thereby accelerating the extension of interfacial cracks.

However, the aforementioned modulus-heterogeneous anti-icing surfaces rely on elastic deformation of a soft substrate to generate cracks, and typically require thicknesses of several hundred micrometers or even millimeters to achieve low ice adhesion. Such coating thicknesses are not conducive to large-scale application. Furthermore, these coatings usually rely on methods such as template-based, spin-coating, or multi-step preparation techniques; due to the complexity of these fabrication processes, they are difficult to apply widely on the surfaces of various equipment.

### SUMMARY

To address the issues with the prior art described above, the present disclosure proposes an anti-icing coating and preparation method for effectively promotes initiation and rapid extension of interfacial cracks (i.e., the crack-sensitive effect). The anti-icing coating can be formed in a single step by spraying an emulsion paint and achieves highly efficient deicing based on the crack-sensitive effect at a thickness of only ~50 μm.

Technical solution of the present disclosure is:

A crack-sensitive high-efficiency deicing coating, including: a soft, hydrophobic coating matrix; and a hard particulate phase having a high cross-linking density dispersed in the matrix.

In some embodiments, the soft and hydrophobic coating matrix is soft resin; the hard particulate phase with high cross-linking density within the coating is formed by a cross-linking reaction between organic polysilazane resin (OPSZ) and the aqueous phase in emulsion paint.

In some embodiments, the soft resin includes: room-temperature-curing silicone resin, oil-based polyurethane, or silicon fluoride resin.

In some embodiments, the hard particulate phase formed by the cross-linking reaction has a uniform particle size (~5-20 μm) and is randomly distributed within the soft coating; the random distribution (either close to or far from a surface of the coating) results in a heterogeneous distribution of modulus across coating surface.

In some embodiments, a Young's modulus of the soft, hydrophobic coating matrix is close to intrinsic modulus of silicone resin, ranging from 1 to 3 MPa; regions within the coating containing a hard particulate phase exhibit a higher Young's modulus, ranging from 5 to 20 MPa.

A preparation method of the crack-sensitive high-efficiency deicing coating employing a spray coating process, including:
s1: preparation of oil phase solution.

A hydrophobic soft resin is used as the film-forming material; take 4 parts based on a weight of the hydrophobic soft resin; select organic solvent that is compatible with the film-forming material but immiscible with water, surfactant suitable for water-in-oil emulsion, and anti-settling agent suitable for oil-based paint; mix the materials and stir for 20-30 minutes at 40-50 °C to form a uniform solution, then cool to room temperature and set aside.

In some embodiments, take 8-10 parts of the organic solvent that is compatible with the film-forming material but immiscible with water; take 0.04-0.12 parts of the surfactant suitable for water-in-oil emulsion; and take 0.1-0.25 parts of the anti-settling agent suitable for oil-based paint.

In some embodiment, the hydrophobic soft resin is room-temperature-curing silicone resin, oil-based polyurethane, or silicon fluoride resin; the organic solvents is butyl acetate, ethyl acetate, or xylene, the amount can be increased or decreased as needed to adjust viscosity of the coating; the surfactant is oil-soluble surfactant with an HLB value of 3-6, specifically is Span 20, Span 60, Span 80, or PEG-30 dimeric hydroxystearate; the anti-settling agent is oil-soluble long-chain polymer products, specifically is polyamide wax or modified polyurea solution.
s2: preparation of aqueous phase solution.

Take 3.5-10 parts of purified water, add water-soluble thickening surfactant to adjust viscosity of the aqueous phase, stir thoroughly at room temperature to form aqueous solution;

In some embodiments, the water-soluble thickening surfactant is small molecular sodium polyacrylate; a recommended dosage is 1-5 wt % based on the weight of pure water.
s3: mixing of emulsion paint.

Add the aqueous phase solution obtained in s2 to the oil phase solution obtained in s1, stir vigorously at room temperature for 20-30 minutes to form a final emulsion paint.
s4: addition of cross-linking agent before spraying.

Add resin curing agent and 0.1-0.4 parts of room-temperature-curing OPSZ (solid content>98%) to the emulsion paint obtained in s3; stir vigorously at room temperature for 10-20 minutes before spraying to obtain emulsion paint added with cross-linking agent.

In some embodiments, a recommended amount of resin curing agent is 0.4-0.6 parts.
s5: implementation of spraying.

Take the obtain emulsion paint added with cross-linking agent in s4 to place in a low-pressure spray gun cup, spray on a target substrate, control spray parameters (such as spray air pressure, spray distance, spray stroke, travel speed, spray coverage, and paint consumption) to adjust thickness and roughness of the coating film.
s6: cross-linking and curing of coating.

Place a sprayed surface in a ventilated area at room temperature for natural curing; as solvent evaporates, the soft resin cross-links and solidifies into a low modulus coating body; component of OPSZ is in-situ cross-link with aqueous droplets in the emulsion paint to form a hard phase with high modulus; ultimately form a crack-sensitive highly-efficiency deicing coating.

Advantages of the present disclosure are:
(1) The present disclosure provides an environmentally friendly deicing coating formulation that can be applied via manual or mechanical spraying to produce thin (~50 μm) deicing coatings on any equipment surface at scale.
(2) The present disclosure utilizes in-situ cross-linking at emulsion interface to achieve a one-step construction of a deicing coating with heterogeneous elastic modulus. This cross-linking mechanism transforms the droplets in the emulsion into hard particles with uniform particle sizes (~5-20 μm) that are randomly distributed within the soft coating.
(3) The highly effective deicing coating produced by the present disclosure exhibits a crack-sensitive effect. When accumulated ice on the coating surface is subjected to external forces or gravity, the high-modulus sites on the coating surface amplify local stresses and promote buckling deformation in surrounding softer regions, leading to a formation of interfacial microcracks. These numerous interfacial microcracks act as defects at adhesion interface, significantly reducing ice adhesion strength. Simultaneously, under a continuous action of external forces or gravity, these microcracks accelerate their extension and coalescence, thereby achieving efficient fracture at the ice-coating interface.
(4) The highly efficient deicing coating proposed in the present disclosure possesses the ability to promote interfacial fracture across multiple scales. Under large-scale adhesion conditions, the coating induces aggregation and coalescence of microcracks to form macroscopic cracks and promotes rapid propagation along the interface, thereby achieving efficient fracture of the large-scale ice-adhesion interface.
(5) The high-efficiency deicing coating proposed in the present disclosure exhibits outstanding static passive deicing performance. A square tray (approximately 32×16 cm) coated with the present material allows a 1 cm-thick layer of ice to detach spontaneously under the force of gravity, which implies that surfaces coated with the material can similarly allow larger areas of accumulated ice to detach spontaneously under gravity.
(6) The highly efficient deicing coating proposed in the present disclosure exhibits outstanding dynamic passive deicing performance. When applied to drone rotors, the coating allows ice to be easily shed from rotor blades via centrifugal force, with deicing performance significantly superior to that of commercial superhydrophobic coatings (such as NeverWet). The coating holds promise for application on blades of wind turbines, helicopter rotors, and other similar components to achieve highly efficient passive deicing.
(7) The present disclosure provides a basic framework for designing anti-icing coatings based on emulsion paints, which enables the development of anti-icing coatings that balance mechanical robustness and modulus heterogeneity by substituting film-forming resins and adjusting liquid-phase components.

### BRIEF DESCRIPTION OF THE DRAWINGS

FIG. 1 shows a main composition of the emulsion paint proposed in the present disclosure and a formation process of the modulus-heterogeneous anti-icing coating. In FIG. 1, silicone polymer chains cross-link and cure to form a low-modulus coating matrix; component of OPSZ cross-links in situ with the aqueous phase droplets in the emulsion paint to form a high-modulus, hard phase.

FIG. 2 shows a simplified structure of OPSZ and reaction process for forming a highly cross-linked network structure; where R is an organic functional group, such as —CH₃.

FIG. 3A shows a surface morphology of the coating; FIG. 3B shows an internal phase distribution of the coating; FIG. 3C shows a distribution of elastic modulus on the coating surface (measured by atomic force microscopy), demonstrating the heterogeneous distribution of modulus on the surface.

FIG. 4 shows a schematic diagram of mechanism inducing interface microcracks in the high-efficiency deicing coating prepared by the present disclosure.

FIG. 5 shows a schematic diagram of an experimental setup used to test ice adhesion properties of specimens and observe evolution of interfacial cracks.

FIG. 6 shows an evolution process of interfacial cracks during deicing of three coatings in Embodiment 1, Comparative Embodiment 1, and Comparative Embodiment 2.

FIG. 7A shows force-time curves for the three coatings during adhesion of small-sized (15×15 mm) ice; FIG. 7B shows traction-separation curves (i.e., stress-displacement curves) during shear deicing; where the peak of the curve represents maximum shear strength, area under the curve represents interfacial fracture energy during deicing; FIG. 7C summarizes ice adhesion strength and deicing work for the three surfaces.

FIG. 8 compares deicing force ~F (deicing force per unit width) of crack-sensitive coating (CSC) prepared according to the present disclosure and state-of-the-art low interfacial toughness coating (Science. 2019, 364:371-375) at different ice-adhesion interface lengths.

FIG. 9 shows a propagation of an interfacial crack in the CSC prepared in Embodiment 2 during the removal of a 20-cm-long ice block.

FIG. 10A is a tray sprayed with the CSC proposed by the present disclosure, which can easily achieve self-weight detachment of the ice layer; FIG. 10B is a tray coated with the soft silicone coating from Comparative Embodiment 1, which adheres firmly to the ice and needs to be vigorously shaken to remove the ice layer.

As captured by a high-speed camera in FIG. 11A, the blade coated with CSC sheds accumulated ice first during blade rotation, while neither the superhydrophobic coating (SHC) nor the pristine surface (Bare) exhibits ice detachment. FIG. 11B shows a cyclic deicing performance of the rotor in a continuous icing environment, the vertical axis represents ice thickness at a point 5 cm from the rotor axis (circled in the inset), over a period of 160 minutes, the blade with CSC exhibited a highest deicing frequency and the thinnest ice detachment thickness.

FIG. 12A shows elastic modulus distributions of soft silicone coating (from Comparative Embodiment 1), FIG. 12B shows elastic modulus distribution of OPSZ-0 coating (from Embodiment 5); FIG. 12C shows elastic modulus distributions of OPSZ-0.6 CSC (from Embodiment 5, identical to Embodiment 1).

FIG. 13A shows the deicing characteristic curves of coating with an OPSZ content of 0 g in Embodiment 5; FIG. 13B shows the deicing characteristic curves of coating with an OPSZ content of 0.2 g in Embodiment 5; FIG. 13C shows the deicing characteristic curves of coating with an OPSZ content of 0.4 g in Embodiment 5; FIG. 13D shows the deicing characteristic curves of coating with an OPSZ content of 0.6 g in Embodiment 5 (the same as Embodiment 1); FIG. 13E shows the deicing characteristic curves of coating with an OPSZ content of 0.8 g in Embodiment 5. The bold curve represents an average of the remaining curves.

FIG. 14 shows a comparison of the deicing performance of coatings with different water phase mass fractions in Embodiment 6; E20 correspond to water phase mass fractions of 20 wt %, E30 correspond to water phase mass fractions of 30 wt % (the same as Embodiment 1), E40 correspond to water phase mass fractions of 40 wt %.

FIG. 15 shows a comparison of the deicing performance of coatings with different surface roughness in Embodiment 7; where the surface root mean square roughness (Sq) of coating R1 is ~1.32 μm, the Sq of coating R2 is ~1.46 μm; the Sq of coating R3 is ~1.55 μm.

### DETAILED DESCRIPTION

Specific embodiments of the present disclosure will be further described below with reference to the accompanying drawings and the technical description.

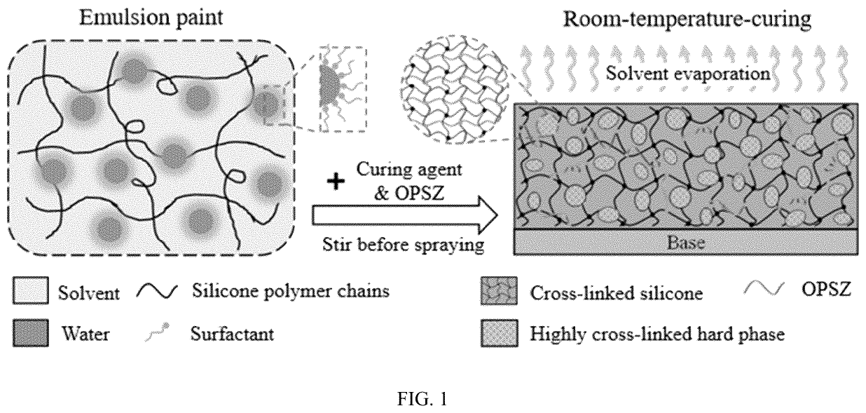

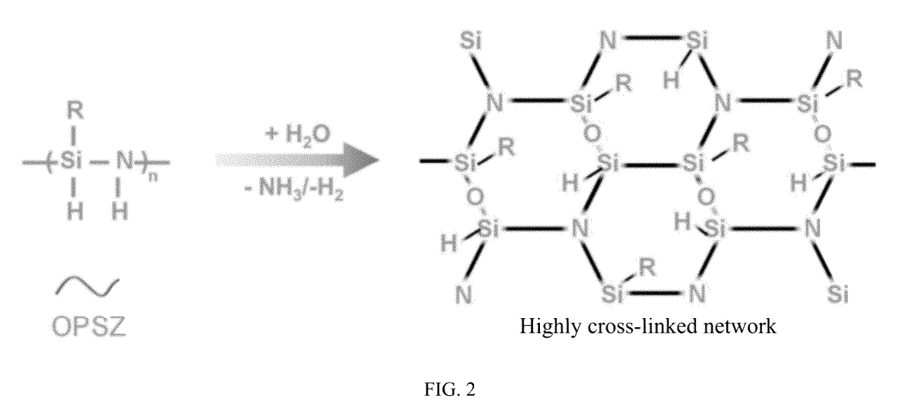

As shown in FIG. 1, a key preparation method of the crack-sensitive high-efficiency deicing coating based on spray-coating method provided by the present disclosure involves formulating a specially designed emulsion paint and applying via spraying to form a two-phase coating including soft and hard components with varying cross-linking densities. The soft matrix is formed by hydrophobic film-forming resin in the paint, while the hard particle phase embedded within the soft matrix is generated by a reaction between the aqueous phase droplets in the paint and the OPSZ, as illustrated in FIG. 2. The distribution density of the hard phase can be controlled by adjusting the mass fraction of the aqueous phase in the emulsion, while modulus differences on the coating surface and overall average modulus can be controlled by adjusting the OPSZ content.

The emulsion paint is water-in-oil emulsion; nonionic surfactants with low HLB values (3-6), such as Span 80, are preferred for stabilizing the emulsion interface. Oil-soluble long-chain polymer products (such as polyamide waxes and modified polyurea solutions) are preferred as anti-settling agent to form a three-dimensional network structure within the coating solution, increasing thixotropy and aiding in suspension of emulsion droplets; and additionally help prevent sagging when sprayed onto vertical surfaces. A mass fraction of the aqueous phase in emulsion paints should be controlled between 20-50 wt %, too low is not conducive to a formation of a stable emulsion, while too high may disrupt film continuity or cause a phase transition (resulting in an oil-in-water emulsion). A small amount of water-soluble surfactant may be added to the aqueous phase solution for thickening; low-molecular-weight sodium polyacrylate (Mw≈5000) is preferred.

The silicone resin used in the embodiments is purchased from Osborn (China) Co., Ltd., model 195T; Span 80 is purchased from Aladdin, a specification is non-ionic surfactant; polyamide wax anti-settling agent is purchased from Shenzhen Jitian Chemical Co., Ltd., model 6900-20X; organic polysilazane resin is purchased from Shenzhen Weijing High tech Materials Technology Co., Ltd., model NS3620; sodium polyacrylate is purchased from Aladdin, with a specification of 45% aqueous solution, Mw≈4500.

### Embodiment 1

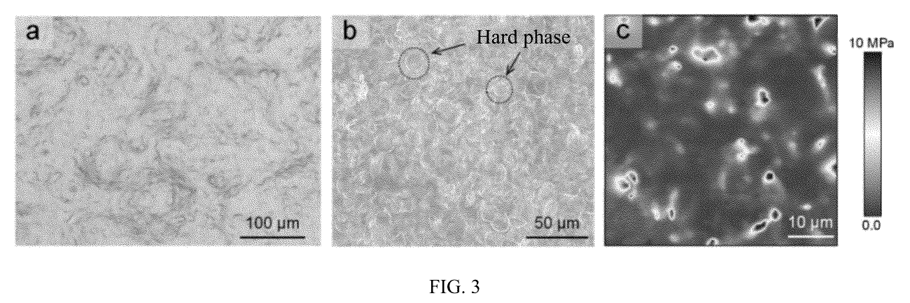

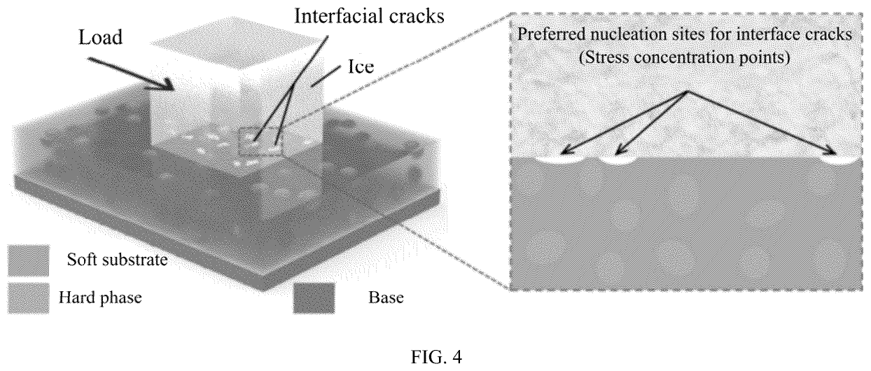

To prepare a crack-sensitive coating (CSC), first add 8 g of silicone resin precursor, 0.16 g of Span 80, and 0.4 g of polyamide wax anti-settling agent to 20 g of butyl acetate. Stir at high speed (~1500 rpm) on a magnetic stirrer at 40 °C for 30 minutes to form an oil phase solution and cool to room temperature. Then add 12 g of deionized water (containing 3 wt % sodium polyacrylate) and stir at high speed for 30 minutes to form an emulsion paint with a mass fraction of 30 wt %. Before spraying, add 1.2 g of silicone resin curing agent and 0.6 g of OPSZ and stir at a high speed for 15 minutes to obtain a mixture. Spraying the mixture onto a surface of a clean glass slide (75×25×1 mm) using a low-pressure spray gun (Iwata, LPH-80), air-dried at room temperature for 3 days to ensure complete curing. The spraying process followed controlled spray parameters, including spray distance, spray stroke, spray coverage, travel speed, and spray air pressure. Adjust the number of spray passes (or paint consumption) to control the coating thickness to ~50 μm. The resulting coating exhibited a continuous surface (FIG. 3(a)), where internal particle sizes of the hard phase primarily distributed between 10-15 μm (FIG. 3(b)). Variations in surface elastic modulus are determined jointly by distribution (random) of hard-phase particles within the coating and the soft matrix, where elastic modulus of the soft matrix is ~2 MPa, while regions containing hard phase exhibit values of 5-10 MPa (FIG. 3(c)). A schematic diagram illustrating the principle of the coating induces interfacial crack nucleation through stress concentration sites during the deicing process is shown in FIG. 4.

### Comparative Embodiment 1

Preparation of a control sample—a soft silicone coating containing no hard-phase particles. Mix 24 g of butyl acetate with 8 g of silicone resin precursor, add 0.32 g of polyamide wax, stir thoroughly at 40 °C and cool to room temperature; before spraying, add 1.2 g of silicone resin curing agent and stir for 15 minutes. The spraying process followed the same steps as in Embodiment 1, resulting in a soft silicone coating with a thickness of ~50 μm.

### Comparative Embodiment 2

Preparation of a control sample—a hardened silicone coating (without hard phase particles). Based on the preparation method described in Embodiment 1, add 1.2 g of silicone resin curing agent and 0.6 g of OPSZ (same amount as in Embodiment 1) before spraying, and stirring for 15 minutes. The spraying process followed the same steps as in Embodiment 1, resulting in a hardened silicone coating with a thickness of ~50 μm.

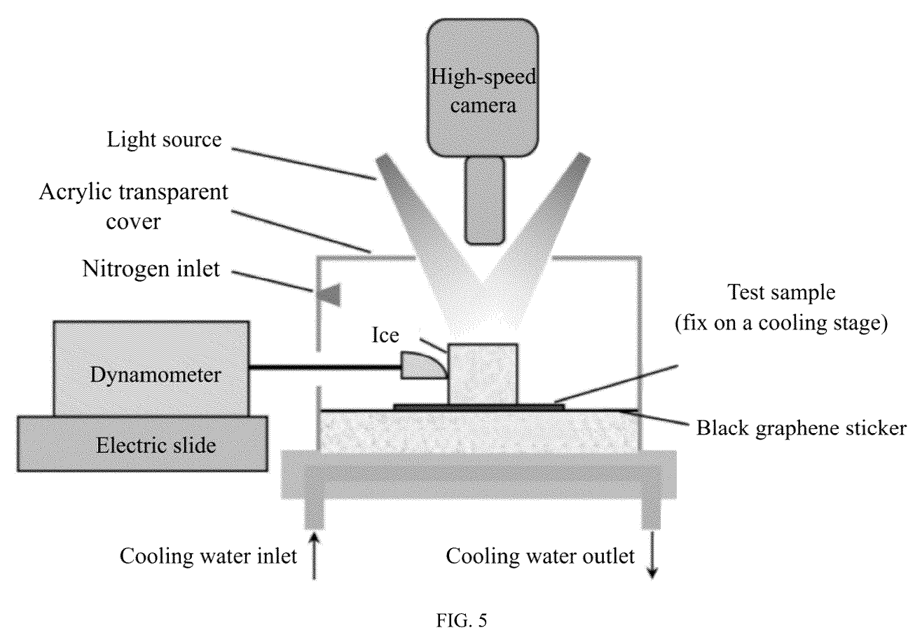

Conduct deicing performance tests on samples prepared according to Embodiment 1, Comparative Embodiment 1, and Comparative Embodiment 2. As shown in FIG. 5, fix the test samples on a cooling stage maintained at −10 °C, frozen 15×15×6 mm ice block onto the sample surface. A dynamometer is mounted on an electric slide and move at a constant speed of 0.1 mm/s, a dynamometer probe is positioned 3 mm from the sample surface. Simultaneously, use a high-speed camera to record the evolution process of interface cracks during deicing above the ice block. To ensure clear imaging, use degassed deionized water to freeze the ice block, and introduce nitrogen into a transparent acrylic cover to ensure the air is dry, thereby preventing frost formation on the ice block surface from affecting image clarity.

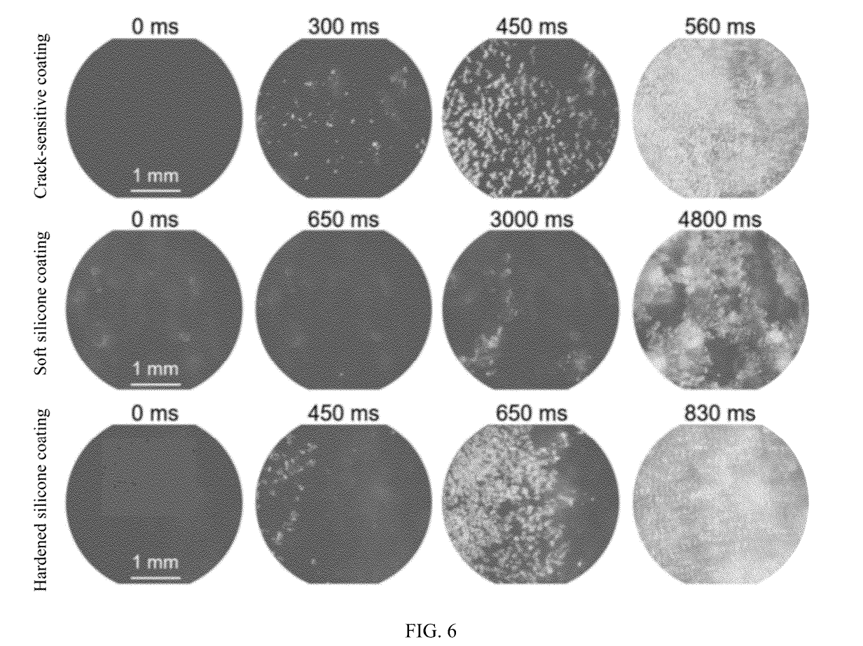

Numbering the three samples from Embodiment 1 as S1, Comparative Embodiment 1 as S2, and Comparative Embodiment 2 as S3; interfacial crack evolution behaviors are shown in FIG. 6. Interface crack in the ice-CSC interface exhibits multiple nucleation sites and ultra-rapid extension, completely penetrating the interface in only 560 ms, causing instantaneous separation of ice and coating; the soft silicone coating exhibits fewer crack initiation points and slow crack extension, where the crack still not penetrate the interface at 4800 ms. Compared to S1, the hardened silicone coating requires a longer time to accumulate energy for interfacial crack initiation; at t=450 ms, its crack area is comparable to that of S1 at t=300 ms, and eventually completes interfacial fracture within 830 ms.

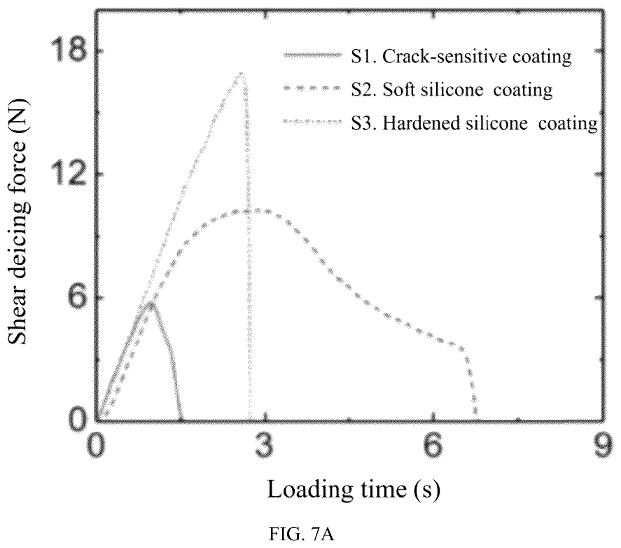

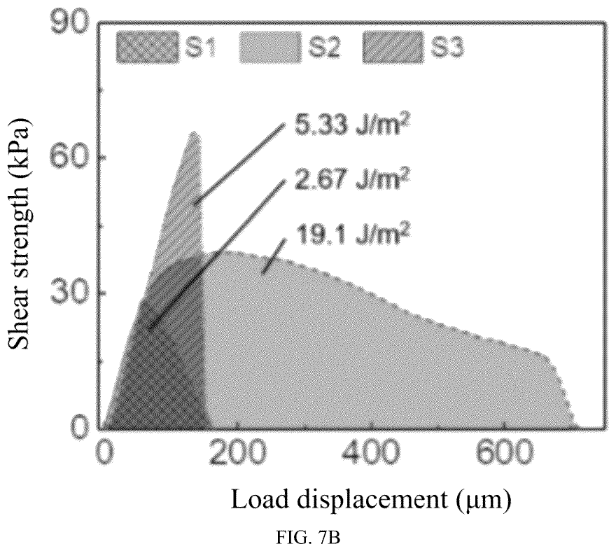

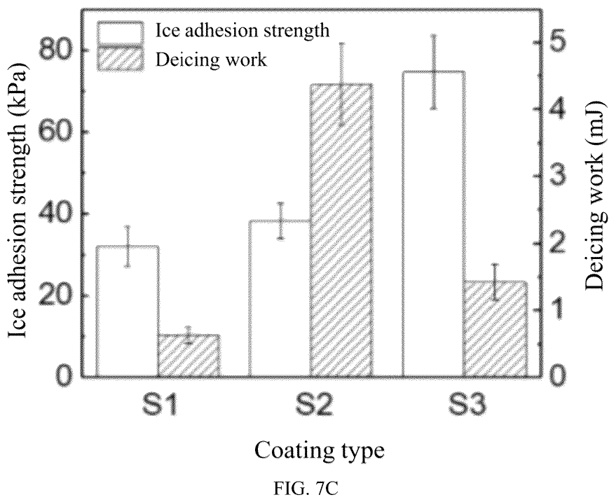

FIG. 7(a) shows force-time curves for deicing of the three coatings, where coating S1 (the CSC) exhibiting a lowest peak deicing force and fastest ice-coating separation rate (within ~1.5 s); FIG. 7(b) shows traction-separation curves for the three surfaces, with area under the curve representing the deicing fracture energy; FIG. 7(c) compares ice adhesion strength and deicing work for the three surfaces, with sample S1 achieving both low ice adhesion strength and low deicing energy consumption due to its crack-sensitive effect.

### Embodiment 2

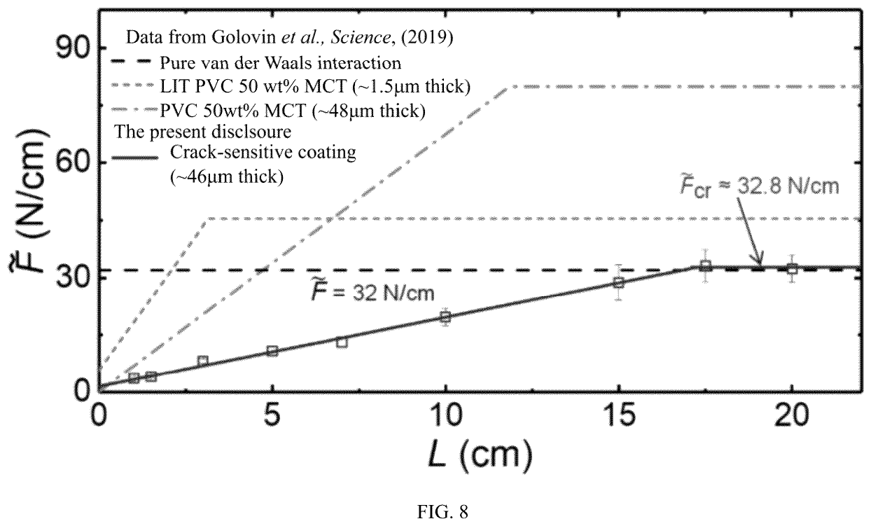

Scale effect testing of deicing on CSC. First, the CSC is prepared following the steps in Embodiment 1 and sprayed onto a glass substrate measuring 21 cm×5 cm×1 mm. Test the prepared samples using the ice adhesion testing method shown in FIG. 5. After freezing ice blocks of 1 cm width, 0.6 cm height, but varying lengths (1-20 cm) onto the sample surface, conduct deicing tests and record peak deicing force. Compare experimental results with the state-of-the-art low-interfacial-toughness coatings (Science. 2019, 364:371-375). The results are shown in FIG. 8. The CSC exhibited lower deicing forces across all adhesion lengths, with a stable value of ~32.8N/cm, which is very close to the van der Waals limit (32 N/cm). Furthermore, slope of the line represents ice adhesion strength of the coating. The results demonstrate excellent cross-scale deicing capability of the CSC of the present disclosure.

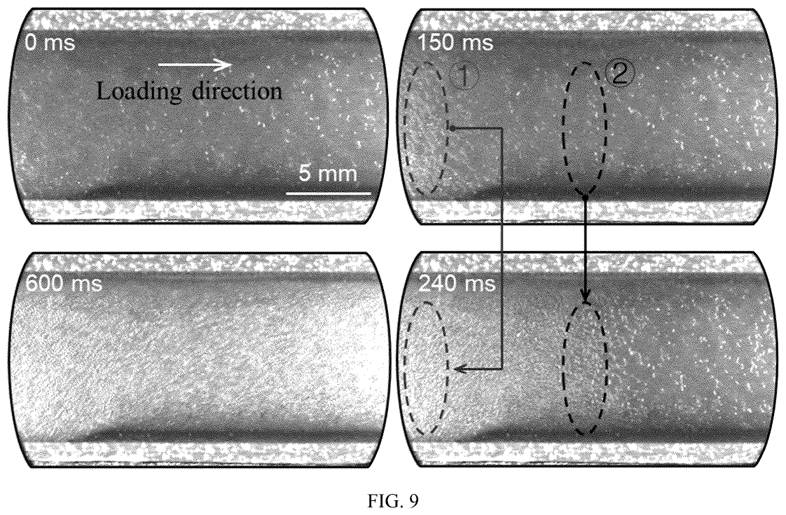

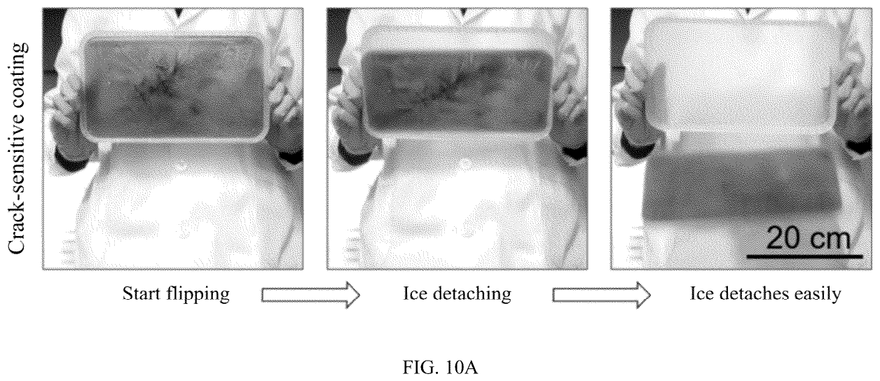

FIG. 9 illustrates a propagation of interfacial cracks in a CSC during a removal of a 20-cm-long ice layer. The microcrack cluster at position \textcircled{1} (t=150 ms) has already interconnected to form a macrocrack by t=240 ms, at which point a new microcrack cluster formed at position \textcircled{2}; as stress propagated, microcracks at position \textcircled{2} also coalesced to form a forward-propagating macrocrack. This process reveals microscopic mechanism by which the CSC achieves efficient fracture at a large-scale ice-adhesion interface.

### Embodiment 3

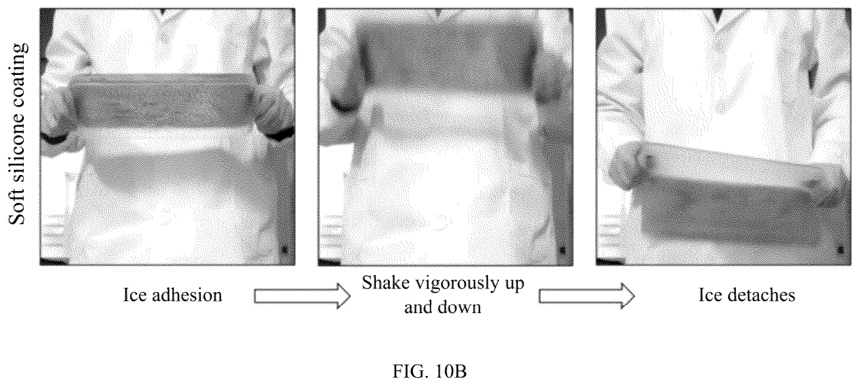

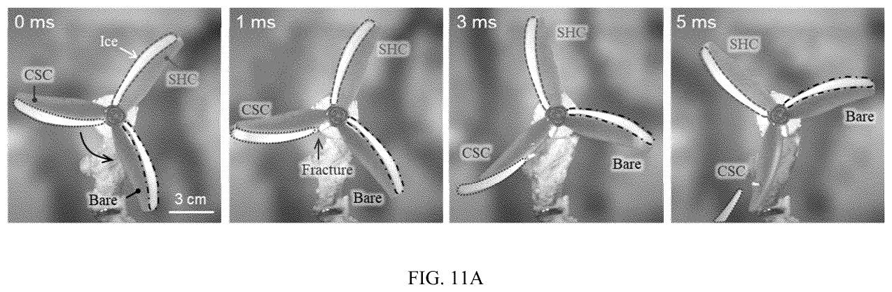

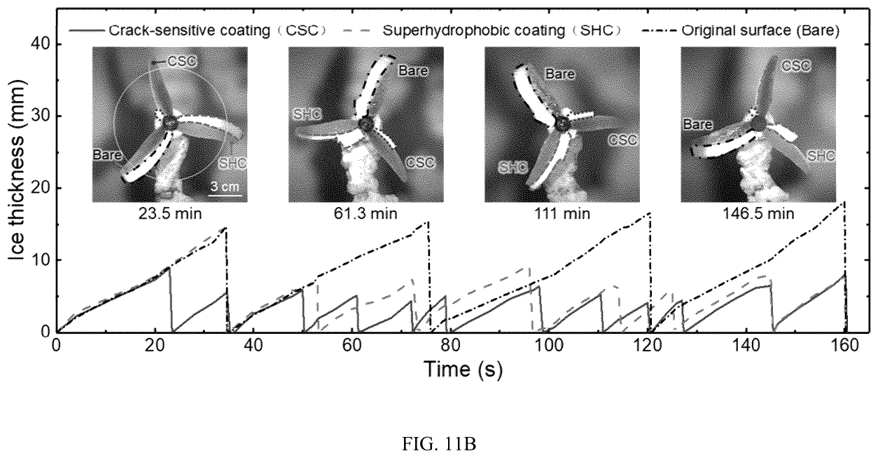

Experimental testing of large-sized ice trays. Prepare PET trays (rigid and resistant to deformation) measuring approximately 32×16×3 cm, spray the coatings to the two PET trays following the method steps described in Embodiment 1 and Comparative Embodiment 1, respectively, resulting in a tray coated with a CSC and a tray coated with a soft silicone coating. Place the two trays in a freezer compartment of a refrigerator (−18 °C) and leveled, add equal amount of water to ensure the water level in each tray is around 9 mm. After freezing for 48 hours, remove the trays by supporting the bottom with one hand. As shown in FIG. 10(a), place the frozen ice-filled trays vertically as a starting position, then gently inverted. When the tray with the CSC is tilted slightly, the ice layer easily fell off; whereas for the tray with the soft silicone coating, even after being inverted with the opening facing downward, the ice layer remained adhered to the tray and required vigorous up-and-down shaking several times before it could be dislodged (see FIG. 10(b)).

### Embodiment 4

Testing the dynamic deicing performance of CSC. Prepare different types of anti-icing coatings to a 5-inch-diameter three-blade drone rotor: spray a CSC onto both sides of a rotor blade following the method described in Embodiment 1; spray a commercial superhydrophobic coating (SHC) (Rust-Oleum Inc., NeverWet) onto both sides of an adjacent blade, with the application process following product instructions; another blade is left untreated and served as a blank control. Mount the rotor on a brushless motor and placed in a chamber maintained at −15 °C and operate continuously at a speed of ~3000 rpm. Simultaneously, use an electric atomizer to generate water mist within the chamber. Ice gradually accumulated on the blade surface until reached a critical mass, at which point centrifugal force overcame the adhesive force with substrate, causing the ice to detach. Using a high-speed camera to record the process.

FIG. 11(a) compares deicing performance of rotor blades with different coatings, showing that the blade with the CSC is the first to shed ice. FIG. 11(b) illustrates cyclic deicing performance of the rotor in a continuous icing environment, where vertical axis represents ice thickness at a point 5 cm from the rotor axis (circled in the inset). A rising curve indicates continuous ice accumulation on the blade, while a sudden drop on the curve indicates ice shedding. Over a period of 160 minutes, the blade with the CSC exhibited highest deicing frequency and thinnest ice detachment thickness. Furthermore, result at 146.5 minutes in the inset indicates that all ice on the surface of the blade with the CSC coating is removed, whereas half of the ice remained on the surface of the blade with the SHC.

### Embodiment 5

Content of OPSZ affects cross-linking density and hardness of the hard phase in the coating of the present disclosure, thereby influencing deicing performance of the coating; therefore, the present embodiment demonstrates effect of OPSZ dosage. Prepare five samples with different OPSZ contents according to the method described in Embodiment 1. Specifically, replace the “addition of 0.6 g OPSZ” in Embodiment 1 with additions of 0 g designated as OPSZ-0, 0.2 g designated as OPSZ-0.2, 0.4 g designated as OPSZ-0.4, 0.6 g designated as OPSZ-0.6, and 0.8 g designated as OPSZ-0.8.

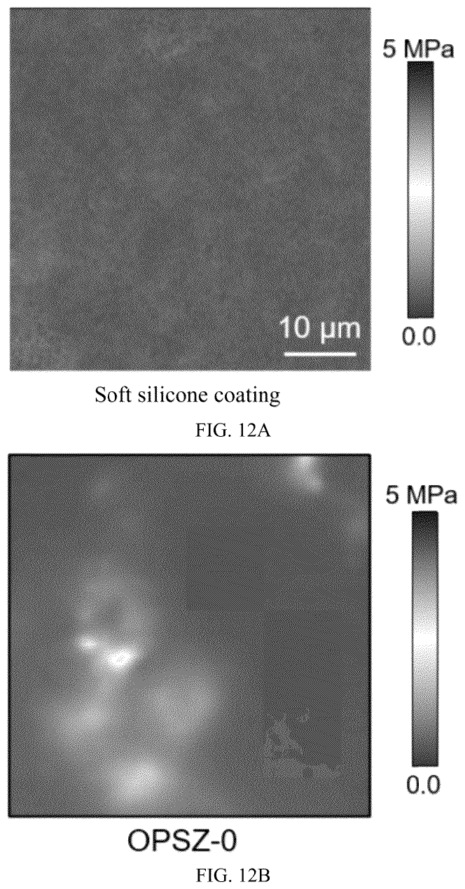

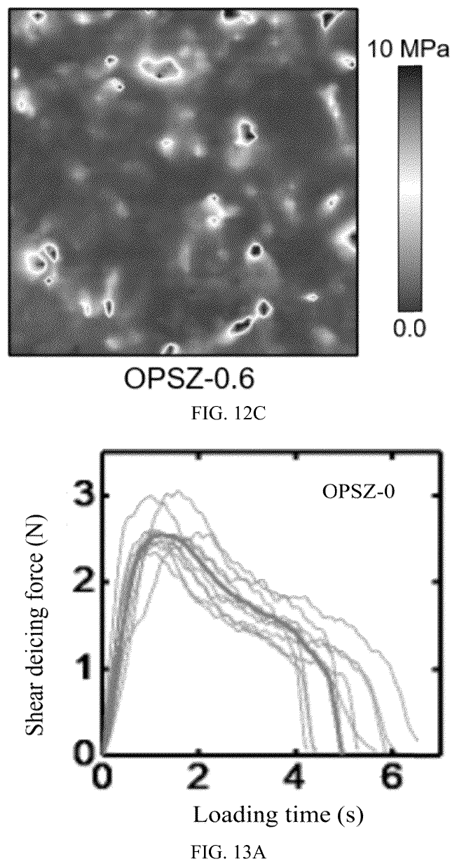

Elastic modulus distributions of the surfaces of samples OPSZ-0, OPSZ-0.6, and the soft silicone coating are shown in FIG. 12. The results indicate that the surface modulus of soft silicone-coated samples is the most uniform, with an average modulus of ~2 MPa; OPSZ-0.6 (the sample from Embodiment 1) exhibits a greatest modulus heterogeneity; in contrast, a modulus distribution of OPSZ-0 lies between the two. The results further confirm the process by which the cross-linking reaction between OPSZ and aqueous phase generates a hard particulate phase.

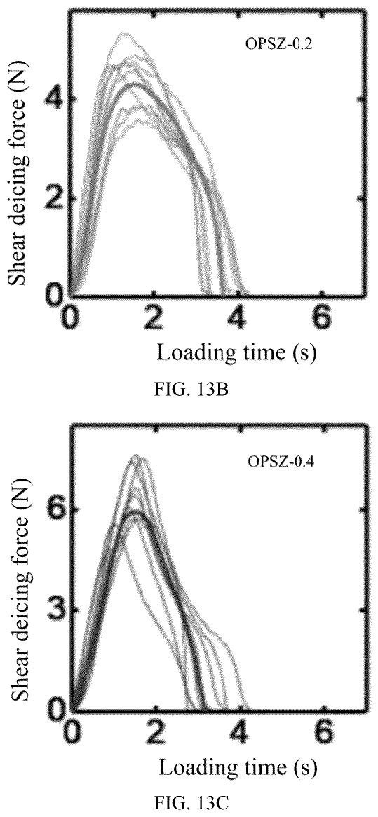

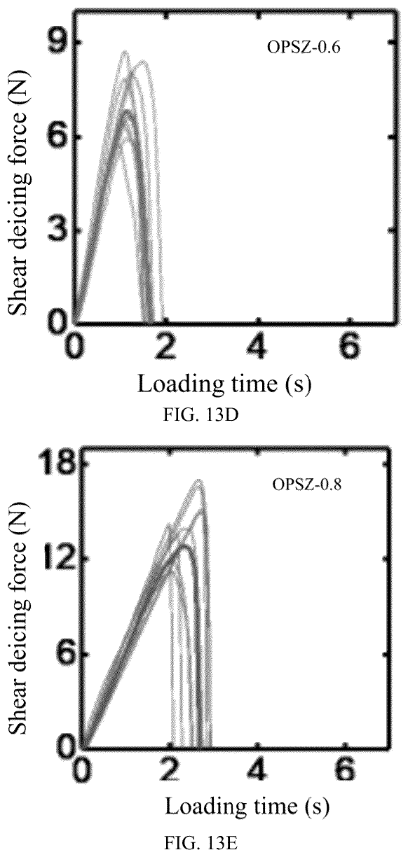

Conduct nine ice adhesion tests on each sample using the test method shown in FIG. 5. Load-time curves for the deicing process are summarized in FIG. 13, the bold curve representing an average of the nine tests. Compared to the sample in Embodiment 1 (OPSZ-0.6), the peak deicing force of OPSZ-0 is only one-third of that of OPSZ-0.6, while the deicing time is approximately three times longer. When compared to the deicing curves of the soft silicone coating (FIG. 7(a), S2), OPSZ-0 still demonstrates a significant deicing advantage. As the OPSZ content increases, the peak deicing force gradually rises, and the deicing time gradually decreases. When OPSZ reaches 0.8 g, the deicing force suddenly doubles that of OPSZ-0.6, and the deicing time also begins to increase, deicing characteristics becoming similar to hardened silicone coating (FIG. 7(a), S3). The results indicate that when the OPSZ content does not exceed 0.6 g, crack-sensitive effect of the coating is significant, either substantially reducing the peak deicing force or significantly improving the interfacial fracture efficiency (i.e., shorter deicing time).

### Embodiment 6

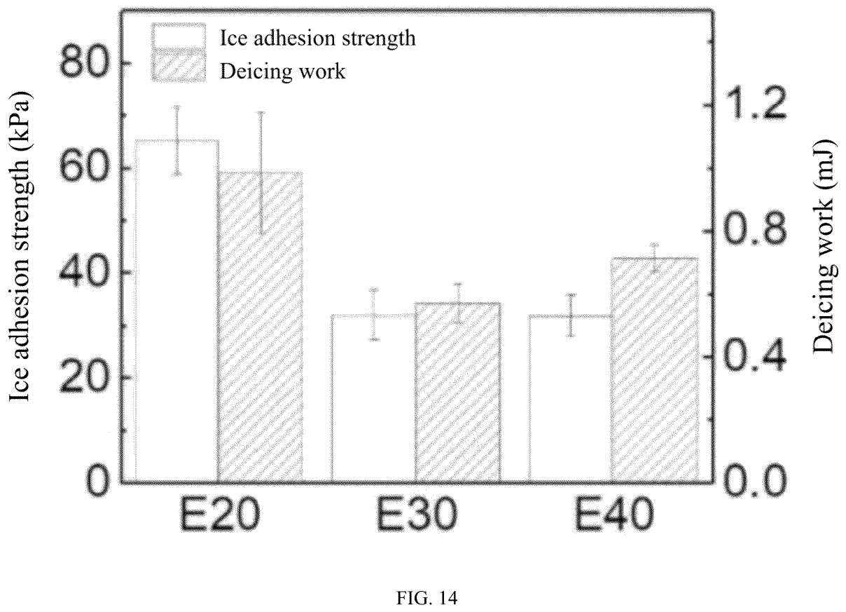

In the coating formulation provided by the present disclosure, the aqueous phase content affects the amount of hard phase within the coating, thereby influencing modulus distribution characteristics of the coating. Therefore, the present embodiment demonstrates the effect of aqueous phase content on deicing performance of the coating. Prepare three samples with different aqueous phase contents according to the method steps in Embodiment 1. Specifically, the step in Embodiment 1 replace “add 12 g of deionized water (containing 3 wt % sodium polyacrylate)” with adding 7 g, 12 g, and 18.7 g of deionized water (containing 3 wt % sodium polyacrylate). Design the prepared coatings with 7 g of deionized water (containing 3 wt % sodium polyacrylate) as E20, the prepared coatings with 12 g of deionized water (containing 3 wt % sodium polyacrylate) as E30, and the prepared coatings with 18.7 g of deionized water (containing 3 wt % sodium polyacrylate) as E40. Test the samples according to the method shown in FIG. 5, and the deicing performance results are summarized in FIG. 14. Among them, E20 exhibits the highest ice adhesion strength and deicing work, while E30 and E40 have similar ice adhesion strengths, E40 shows slightly higher deicing work. This suggests that E20 may lack sufficient stress-concentration phases (hard phase particles) to achieve a crack-sensitive effect.

### Embodiment 7

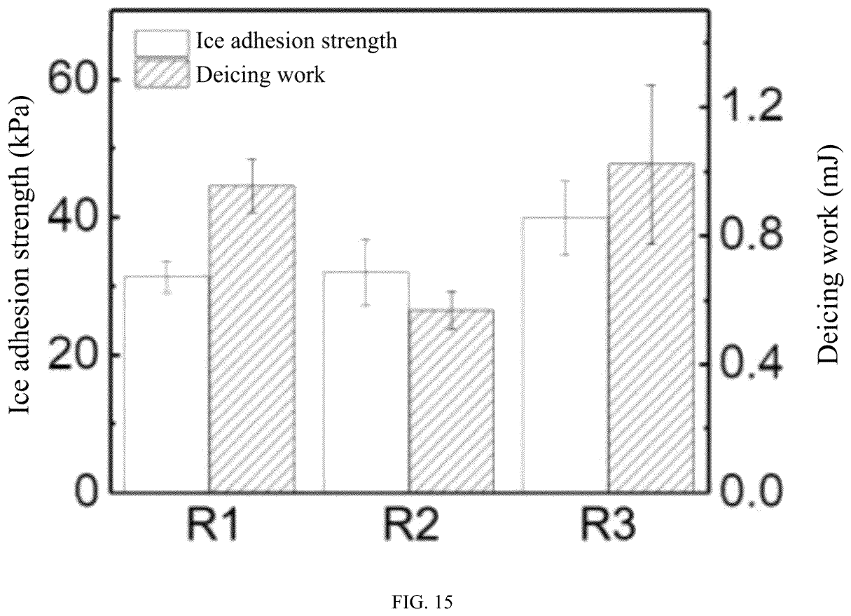

Surface roughness is an intrinsic property of the coating during preparation and also influences the adhesion characteristics at the ice-substrate interface. The present embodiment demonstrates optimization process of controlling surface roughness on the deicing performance of the coating of the present disclosure. Following the method steps in Embodiment 1 and adjusting the spraying process to prepare three samples with different surface roughness (where the surface roughness is primarily controlled by adjusting the spraying process). Use a white light interferometer to measure the surface roughness of the prepared coatings. Root-mean-square roughness (Sq) of the three surfaces is ~1.32 μm, designated as R1, ~1.46 μm designated as R2, and ~1.55 μm designated as R3. Test the samples according to the procedure shown in FIG. 5, and the deicing performance results are summarized in FIG. 15. The ice adhesion strength of the medium-roughness sample R2 Is comparable to that of R1, but the deicing work is significantly lower than that of R1. For the sample with the highest roughness, R3, both ice adhesion strength and deicing work increased moderately. This indicates that an appropriate level of roughness does not significantly increase ice adhesion strength but is beneficial for significantly reducing deicing work; however, excessive roughness may slightly reduce deicing effectiveness. Therefore, the CSC of the present disclosure can achieve improved deicing performance through further fine-tuning of surface roughness. Furthermore, since coating surface roughness is determined by multiple factors such as coating formulation, spraying process, and drying conditions, practitioners can fine-tune the coating formulation and spraying process under specific application conditions to adjust surface roughness and optimize deicing performance.

The present disclosure is not limited to the above embodiments. Without departing from the spirit of the present disclosure, those skilled in the art may, as needed, add conventional additives (such as surfactants, anti-settling agents, leveling agents, defoamers, etc.) or adjust the amounts of these additives and resin curing agents, or replace the resins used in the present disclosure with similar resin products; such improvements and substitutions should still fall within the scope of protection of the present disclosure.

What is claimed is:

1. A crack-sensitive high-efficiency deicing coating, comprising: soft and hydrophobic coating matrix and hard particulate phase with high cross-linking density within the coating; wherein the soft and hydrophobic coating matrix is soft resin; the hard particulate phase with high cross-linking density within the coating is formed by a cross-linking reaction between organic polysilazane resin (OPSZ) and the aqueous phase in emulsion paint; the hard particle phase generated by the cross-linking reaction has uniform particle size and is randomly distributed within the soft and hydrophobic coating matrix.

2. The crack-sensitive high-efficiency deicing coating according to claim 1, wherein the soft resin comprises: room-temperature-curing silicone resin, oil-based polyurethane, or silicon fluoride resin.

3. The crack-sensitive high-efficiency deicing coating according to claim 1, wherein Young's modulus of the soft, hydrophobic coating matrix is 1-3 MPa; Young's modulus of regions within the coating containing hard particulate phase is 5-20 MPa.

4. A preparation method of the crack-sensitive high-efficiency deicing coating, based on a spray coating method, comprising:
s1: preparation of oil phase solution;
select hydrophobic soft resin as film-forming material; take 4 parts based on a weight of the hydrophobic soft resin; select organic solvent that is compatible with the film-forming material but immiscible with water, surfactant suitable for water-in-oil emulsion, and anti-settling agent suitable for oil-based paint; mix the materials and stir for 20-30 minutes at 40-50 °C to form a uniform solution, then cool to room temperature and set aside;
s2: preparation of aqueous phase solution;
take 3.5-10 parts of purified water, add water-soluble thickening surfactant to adjust viscosity of the aqueous phase, stir thoroughly at room temperature to form aqueous solution;
s3: mixing of emulsion paint;
add the aqueous phase solution obtained in s2 to the oil phase solution obtained in s1, stir vigorously at room temperature for 20-30 minutes to form a final emulsion paint;
s4: addition of cross-linking agent before spraying;
add resin curing agent and 0.1-0.4 parts of room-temperature-curing OPSZ to the emulsion paint obtained in s3; stir vigorously at room temperature for 10-20 minutes before spraying to obtain emulsion paint added with cross-linking agent;
s5: implementation of spraying;
take the obtain emulsion paint added with cross-linking agent in s4 to place in a low-pressure spray gun cup, spray on a target substrate, control spray parameters to adjust thickness and roughness of the coating film;
s6: cross-linking and curing of coating;
place a sprayed surface in a ventilated area at room temperature for natural curing; as solvent evaporates, the soft resin cross-links and solidifies into a low modulus coating body; component of OPSZ is in-situ cross-link with aqueous droplets in the emulsion paint to form a hard phase with high modulus; ultimately form a crack-sensitive and efficient deicing coating.

5. The preparation method of the crack-sensitive high-efficiency deicing coating according to claim 4, wherein the soft resin comprises: room-temperature-curing silicone resin, oil-based polyurethane, or silicon fluoride resin.

6. The preparation method of the crack-sensitive high-efficiency deicing coating according to claim 4, wherein Young's modulus of the soft, hydrophobic coating matrix is 1-3 MPa; Young's modulus of regions within the coating containing hard particulate phase is 5-20 MPa.

7. The preparation method of the crack-sensitive high-efficiency deicing coating according to claim 4, wherein take 8-10 parts of the organic solvent that is compatible with the film-forming material but immiscible with water; take 0.04-0.12 parts of the surfactant suitable for water-in-oil emulsion; and take 0.1-0.25 parts of the anti-settling agent suitable for oil-based paint.

8. The preparation method of the crack-sensitive high-efficiency deicing coating according to

4. wherein the hydrophobic soft resin is room-temperature-curing silicone resin, oil-based polyurethane, or silicon fluoride resin; the organic solvents is butyl acetate, ethyl acetate, or xylene; the surfactant is oil-soluble surfactant with an HLB value of 3-6, specifically is Span 20, Span 60, Span 80, or PEG-30 dimeric hydroxystearate; the anti-settling agent is oil-soluble long-chain polymer products, specifically is polyamide wax or modified polyurea solution.

9. The preparation method of the crack-sensitive high-efficiency deicing coating according to claim 4, wherein the water-soluble thickening surfactant is small molecular sodium polyacrylate with a molecular weight of 4,000-8,000; a recommended dosage is 1-5 wt % based on the weight of pure water.

10. The preparation method of the crack-sensitive high-efficiency deicing coating according to claim 4, wherein a recommended amount of resin curing agent is 0.4-0.6 parts.

11. The preparation method of the crack-sensitive high-efficiency deicing coating according to claim 4, wherein spray parameters comprises: spray air pressure, spray distance, spray stroke, travel speed, spray coverage, and paint consumption.
